(19) United States
(12) Patent Application Publication
(10) Pub. No.: US 2013/0119871 A1
(43) Pub. Date: May 16, 2013

(54) METHOD AND SYSTEM FOR CONTROLLING THE LUMINOUS FLUX OF A LIGHTING ARRANGEMENT

(71) Applicants: Matthias Wendt, Wurselen (DE); Peter Luerkens, Aachen (DE)

(72) Inventors: Matthias Wendt, Wurselen (DE); Peter Luerkens, Aachen (DE)

(21) Appl. No.: 13/810,294

(22) PCT Filed: Jul. 19, 2011
(86) PCT No.: PCT/IB11/53220

§ 371 Date: Jan. 15, 2013

(30) Foreign Application Priority Data
Jul. 21, 2010 (EP) 10170247.0

(51) Int. Cl. H05B 37/02

(52) U.S. Cl. CPC H05B 37/02
USPC 315/152

(57) ABSTRACT

The invention relates to a method for controlling the luminous flux of a lighting arrangement (3) for illuminating the interior of a building (5), wherein the lighting arrangement (3) comprises at least one artificial lighting device (17), which artificial lighting device (17) is supplied with electrical power by a power source system (9) comprising a first power source (11) being a photovoltaic device (13) for generating electrical power and an access to at least one second power source (15), the method comprising the steps of: —pre-selecting a luminous flux characteristic curve (47, 49), which specifies a monotonically increasing dependence of the luminous flux of the artificial lighting device (17) on the light intensity outside the building (5); —Determining the light intensity outside the building (5); and Supplying the at least one artificial lighting device (17) with the electrical power required for generating the luminous flux according to said selected luminous flux characteristic curve (47, 49), wherein the photovoltaic device (13) has a power contribution to said amount of required electrical power. The invention further relates to a corresponding photovoltaic lighting system (1) and a data storage device encoding a program to perform the method.

### FIELD OF THE INVENTION

The invention relates to a method for controlling the luminous flux of a lighting arrangement for illuminating the interiour of a building, wherein the lighting arrangement comprises at least one artificial lighting device, which artificial lighting device is supplied with electrical power by a power source system comprising a first power source being a photovoltaic device for generating electrical power and an access to at least one second power source.

The invention further relates to a photovoltaic lighting system and a corresponding data storage device.

### BACKGROUND OF THE INVENTION

Illumination of the interiour of a building includes use of both: artificial lighting devices such as lamps and natural daylight illumination of the interior from outside. Daylighting (through windows, skylights, or other interfaces) is often used as the main source of light during daytime in buildings given its low cost. Artificial lighting represents a major component of energy consumption, accounting for a significant part of all energy consumed worldwide.

Photovoltaic power generation by means of a photovoltaic (PV) device for generating electrical power (a photovoltaic generator comprising a plurality of solar cells) gets increasingly used for the power supply of a lighting arrangement with artificial lighting devices inside of buildings. However the right balance of nominal power of lighting arrangement and peak power of the PV device is still unclear. Especially is it not clear what needs to be done with the surplus electrical power on sunny days when the electrical power generated by the photovoltaic generator is much higher than the drain due to in-house lighting of the artificial artificial lighting devices. On the other hand selecting a low peak power for the photovoltaic device will result in insufficient supply under most exterior lighting conditions and additional power needs to be taken from mains.

Photometry deals with the measurement of visible light as perceived by human eyes. In photometry, luminous flux is a measure of the wavelength-weighted power emitted by a light source and luminous flux is a measure of the wavelength-weighted power emitted by the light source in a particular direction per unit solid angle, both measured values based on the luminosity function, a standardized model of the sensitivity of the human eye. The SI unit of luminous flux is the candela (cd), an SI base unit.

For persons entering an artificially illuminated building from the bright outside, it is convenient not to be subject to an enormous brightness change with respect to the sensitivity of the human eye.

### SUMMARY OF THE INVENTION

It is an object of the invention to provide a method for controlling the luminous flux of a lighting arrangement for illuminating the interiour of a building, a corresponding data storage device encoding a programm to perform the method and a corresponding photovoltaic lighting system for dynamic luminous flux adjustment that adapts the brightness inside the building to the natural brightness outside the building to save energy.

This object is achieved by the present invention as defined in claims 1, 12 and 14.

The method according to the invention comprises the steps of: (a) pre-selecting a luminous flux characteristic curve, which specifies a monotonically increasing dependence of the luminous flux of the artificial lighting device on the light intensity outside the building; (b) determining the light intensity outside the building; and (c) supplying the at least one artificial lighting device with the electrical power required for generating the luminous flux according to said selected luminous flux characteristic curve, wherein the the photovoltaic device has a power contribution to said amount of required electrical power.

The access to the at least one second power source preferably is an access to a a mains supply like the public mains supply.

According to a preferred embodiment of the invention, the luminous flux characteristic curve shows a linear relation between light intensity outside the building and the luminous flux of the artificial lighting device in at least one range of values between a lower limit of luminous flux and an upper limit of the luminous flux. The upper limit of the luminous flux is the maximum luminous flux of the artificial lighting device.

According to another preferred embodiment of the invention, the lower limit of the luminous flux is a minimal luminous flux guaranteing the functional illuminating conditions in the building or at least a respective part of the building illuminated by the corresponding artificial lighting device. These illuminating conditions are for example given by a light sensitivity limit of the human eye, by safety regulations or employment rights.

According to yet another preferred embodiment of the invention, the contribution to said amount of electrical power is a contribution corresponding to the current maximum performance level of the photovoltaic device up to the electrical power needed for the maximum luminous flux of the artificial lighting device.

Preferably, the lighting arrangement comprises a plurality of artificial lighting devices. The artificial lighting devices are distributed in the building for an overall illumination, e.g. an overall uniform illumination. The intensity of this overall illumination depends on the light intensity outside.

According to another preferred embodiment of the invention, the building is devided into a plurality of illumination zones, each with at least one corresponding artificial lighting device for illuminating the respective illumination zone, wherein the artificial lighting devices of at least two different illumination zones are operated with different luminous flux characteristic curves.

According to a preferred embodiment of the invention, a first illumination zone has more direct illumination from outside the building than a second illumination zone and wherein a first luminous flux characteristic curve of the artificial lighting device of the first illumination zone shows a stronger dependence on the exterior light intensity outside the building than a second luminous flux characteristic curve of the artificial lighting device of the second illuminating zone. By this grading the customer need can be addressed that the lighting flux level in rooms without natural daylight gets adjusted higher on days with high exterior light levels (E.g. when leaving an office with windows into a corridor without any windows the light level change should be not too drastic). In a further aspect, the building is divided into zones, defining areas in dependence of their distance to the entrance or other interfaces to natural daylight, e.g. windows. The illumination level of the artificial light is then more strictly adapted to the outside illumination, if the current zone is nearer to an interface to the outside. In turn, zones that are more remote to the outside will receive less modulation of the brightness levels.

According to another preferred embodiment of the invention, the at least one artificial lighting device is a compact fluorescent lamp (CFL) and/or a light emitting diode (LED). A compact fluorescent lamp, also known as a compact fluorescent light or energy saving light, is a type of fluorescent lamp. Many compact fluorescent lamps are designed to replace an incandescent lamp and can fit into most existing light fixtures formerly used for incandescents. Preferanly the LEDs are white-light generating LEDs or a RGB system with the white light being produced by mixing red, green and blue (RGB) colored light emission.

According to a preferred embodiment of the invention, the (day)light intensity outside the building is determined by the use of an additional light sensor. This light sensor preferably comprises a photo sensor.

According to another preferred embodiment of the invention, the light intensity outside the building is determined by the use of an operational parameter of the photovoltaic device. In this embodiment the photovoltaic device has two different tasks: making its own contribution to the amount of reqired electrical power and determining the level of required electrical power. Especially, the operational parameter is the current output electrical power of the photovoltaic device. If the contribution to the amount of electrical power reqired for generating the luminous flux according to said selected luminous flux characteristic curve is the contribution corresponding to the current maximum performance level of the photovoltaic device (up to the electrical power needed for the maximum luminous flux of the artificial lighting device), the method details of the control scheme for the lighting arrangement achieving (i) on one hand low consumption from the second power source and (ii) on the other hand dynamic light brightness adjustments that follows the outdoor lighting conditions.

Another aspect of the present invention is a photovoltaic lighting system, especially a photovoltaic lighting system for performing an aforementioned method, comprising a lighting arrangement for an internal illumination of a building, a controller (controller device) and a power source system for supplying the lighting arrangement. The lighting arrangement comprises at least one artificial lighting device. The power source system comprises a first power source being a photovoltaic device for generating electrical power and an access to at least one second power source, wherein the power source system supplies the artificial lighting device with an adequad amount of electrical power required for generating a luminous flux according to a pre-selectable luminous flux characteristic curve by means of the controller. A power contribution of the photovoltaic device to said amount of required electrical power is selectable by means of the controller. The access to the at least one second power source preferably is an access to a mains supply like the public mains supply. Preferably, the controller is a programmable microcontroller (μC) on a single integrated circuit comprising a processor core, memory, and programmable input/output peripherals.

In general the lighting arrangement comprises at least one artificial lighting device, especially the lighting arrangement comprises a plurality of artificial lighting devices. The at least one artificial lighting device is at least one compact fluorescent lamp and/or at least one light emitting diode.

Preferably the building is devided into different illumination zones, each with at least one corresponding artificial lighting device of the arrangement for illuminating the respective illumination zone, wherein the artificial lighting devices of at least two illumination zones have different luminous flux characteristic curves. A first one of the illuminating zones has more direct illumination from outside the building than a second one, wherein a first luminous flux characteristic curve of the artificial lighting device of the first illumination zone shows a stronger dependence on the exterior light intensity outside the building than a second luminous flux characteristic curve of the artificial lighting device of the second illuminating zone.

According to a preferred embodiment of the photovoltaic lighting system according to the invention, the lighting system further comprises a dimmable driver device, wherein the controller controlls the electrical power supply to the artificial lighting device by means of the dimmable driver device.

The luminous flux outside the building is determined by the use of a light sensor or by the use of an operational parameter of the photovoltaic device. This operational parameter preferably is the output electrical power of the photovoltaic device.

In general the controller or control system comprising the controller can be an analog control system or a digital control system. Preferably the system is realized as a digital control system.

Yet another aspect of the present invention is a data storage device encoding a program in machine-readable and machine-executable form to perform the aforementioned method. In an aforementioned photovoltaic lighting system this machine is the controller, especially a microcontroller, or a computing device of the controller.

### BRIEF DESCRIPTION OF THE DRAWINGS

These and other aspects of the invention will be apparent from and elucidated with reference to the embodiments described hereinafter.

In the drawings:

FIG. 1 shows a schematic representation of a photovoltaic lighting system according to a preferred embodiment of the invention;

FIG. 2 shows a schematic representation of a photovoltaic lighting system according to another preferred embodiment of the invention; and

FIG. 3 shows a luminous flux characteristic curve, which specifies a monotonically increasing dependence of the luminous flux of the artificial lighting device on the output power of a photovoltaic device; and

FIG. 4 shows a ground plan of a building divided into two illumination zones: a first illumination zone surrounding a second illumination zone at the center of the building, the first illumination zone having more direct illumination from outside the building than the second illumination zone.

### DETAILED DESCRIPTION OF EMBODIMENTS

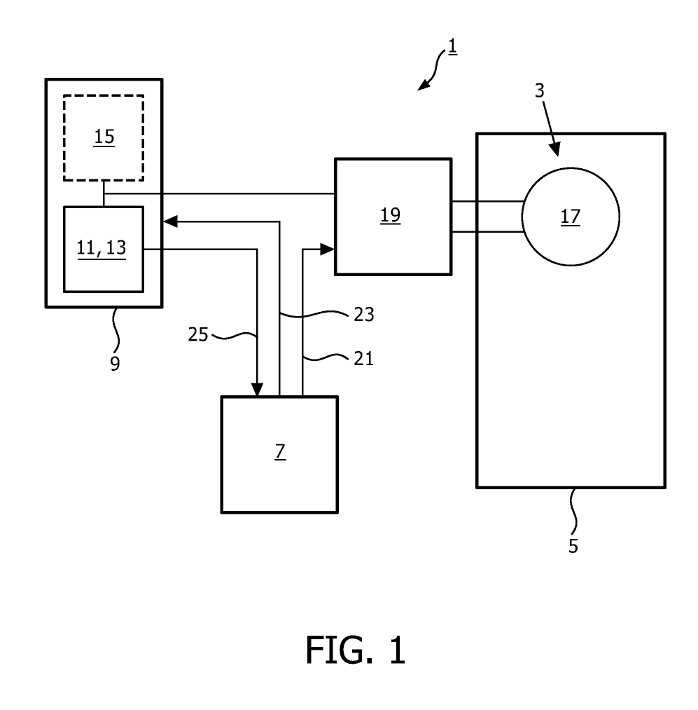

FIG. 1 illustrates a photovoltaic lighting system 1 comprising a lighting arrangement 3 for an internal illumination of a building 5, a controller 7 and a power source system 9 for supplying the lighting arrangement 3 with electrical power. The power source system 9 comprises a first power source 11 being a photovoltaic device 13 for generating electrical power and an access to at least one second power source 15. The photovoltaic device 13 is a photovoltaic generator comprising a plurality of solar cells (not shown). The lighting arrangement 3 comprises one artificial lighting device 17 or a plurality of artificial lighting devices 17, which artificial lighting device(s) 17 is/are at least one compact fluorescent lamp (CFL) and/or at least one light emitting diode (LED).

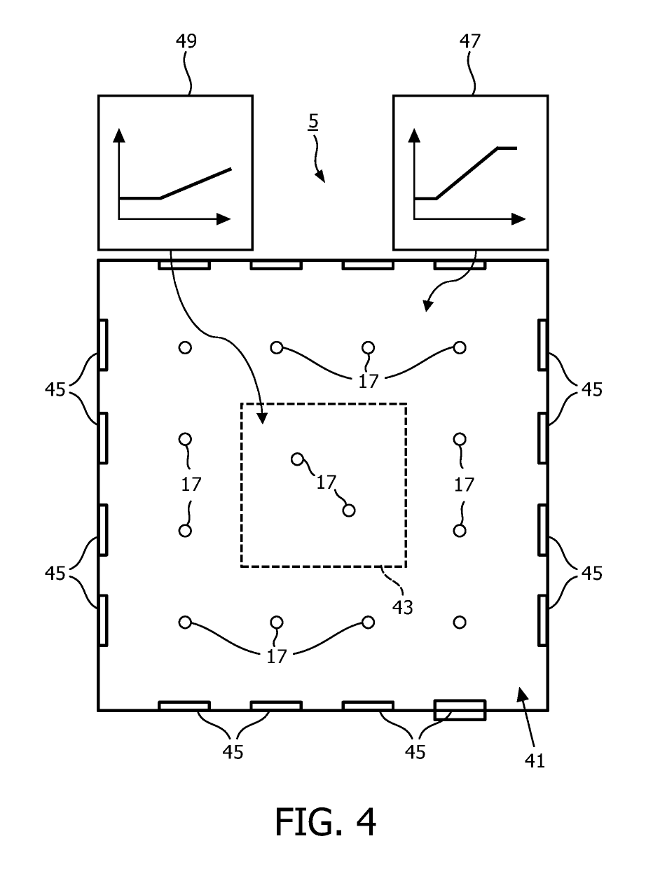

The photovoltaic lighting system 1 further comprises a dimmable driver device 19. The controller 7 controlls the electrical power supply to the artificial lighting device(s) 17 by means of this dimmable driver device 19 (arrow 21). The power source system 9 supplies the artificial lighting device/artificial lighting devices 17 with an adequad amount of electrical power required for generating a luminous flux according to a pre-selectable luminous flux characteristic curve (shown in FIG. 4) by means of the controller 7, wherein a power contribution of the the photovoltaic device 13 to said amount of electrical power is selectable by means of the controller 7 (arrow 23).

The light intensity outside the building 5 is determined by the use of an output electrical power of the photovoltaic device 15 (arrow 25). Therefore the general idea is to control the dim level of the artificial lighting devices 17 dependant on the available energy of the photovoltaic device 13 (the photovoltaic generator). The contribution of the photovoltaic device 13 to said required amount of electrical power is a contribution corresponding to the current maximum performance level of the photovoltaic device 13 up to the electrical power needed for the maximum luminous flux of the artificial lighting device 17.

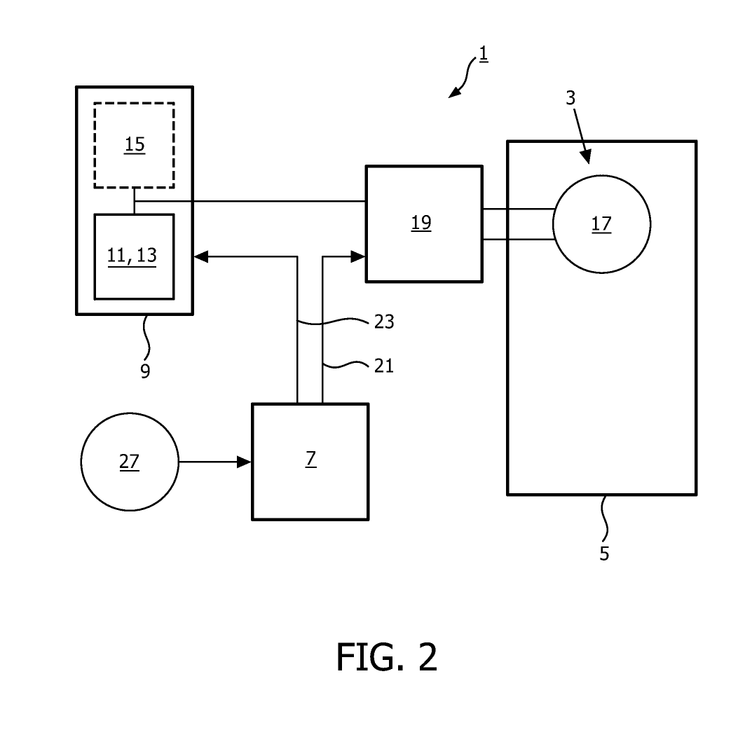

FIG. 2 illustrates a photovoltaic lighting system 1 substantially in compliance with the photovoltaic lighting system 1 shown in FIG. 1. Unlike the system of FIG. 1 the luminous flux outside the building 5 is determined by the use of a light sensor 27. This light sensor 27 comprises a photoelectric cell. The dim level of the artificial lighting devices 17 is controlled depending on an operational parameter of the light sensor 27. Preferably this operational parameter is proportional to the available energy of the photovoltaic device 13.

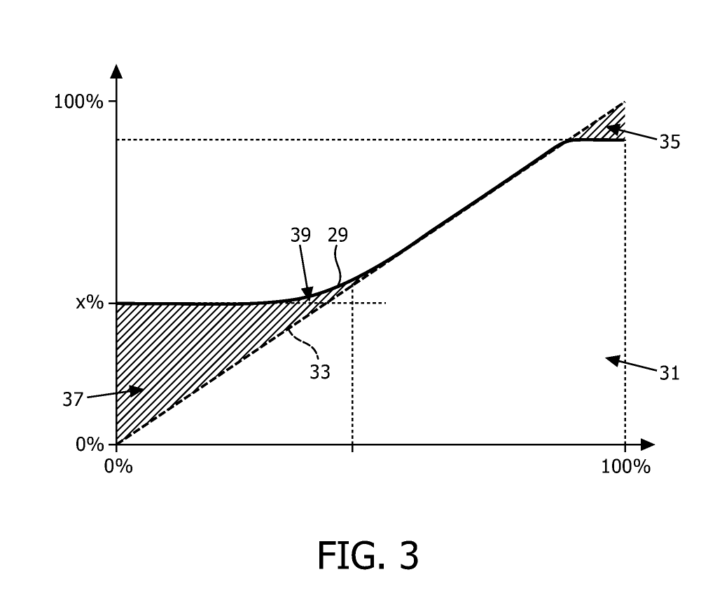

FIG. 3 shows a diagram representing a luminous flux characteristic curve 29, which specifies a monotonically increasing dependence of the luminous flux of the artificial lighting device on the relative photovoltaic power generated by the photovoltaic device 13. In this diagram the light control level is plotted over the power generated by the photovoltaic device 13. This generated power is proportional to the utizable light intensity outside the corresponding building 5. This proportionality relation is schematically shown in FIG. 3. An area 31 below the diagonal 33 is representing the available energy from the photovoltaic device 13 (photovoltaic generator).

If peak power is available, a certain upper limit of the luminous flux (maximum interior flux level at the dimming level DIM=100%—no dimming) is set. If the photovoltaic device 13 has been selected to produce more energy than necessary for supplying the maximum interior flux level , the excess energy (hatched area 35) may be used for other devices or is fed into the power supply system.

When the electrical power generated by the photovoltaic device 13 is decreasing due to reduced (day)light outside the building 5, the indoor luminance flux control will be reduced until a value where the minimum flux requirements for the inside of the building 5 or at least a cooresponding area inside the building 5 is reached (lower limit of luminous flux being a minimum interior flux level at control level DIMx) whereby the flux of the artificial lighting device 17 cannot be further decreased due to a light sensitivity limit of the human eye or safety regulations. At that point the power provided by the photovoltaic device 13 is no longer sufficient to supply the artificial lighting arrangement 3. Electrical power will be added from the at least one second power source 15 like a local storage device and/or mains (other hatched area 37). As depicted in FIG. 3 a takeover 39 can beneficially be realized in a soft take over that reduces optical irritation in the takeover region 39. In addition stress and acoustical problems for the power electronic driver may be omitted. In such a case from PVx relative available PV power additional electrical energy will be used.

For persons entering an artificially illuminated building from the bright outside, it is convenient not to be subject to an enormous brightness change when entering the building 5. Therefore, it is reasonable to set the illumination level in the proximity of the entrances or other areas which are affected by natural (day)light in dependence of the outside illumination levels. Internal areas of the building 5 without any light from outside the building can be sufficiently illuminated then by the required minimum level for safe operation.

The control scheme for such an installation achieves on one hand low consumption from mains supply and on the other hand dynamic light brightness adjustments that follows the outdoor lighting conditions. In this also a psychological customer need can be addressed that the luminance flux level in rooms/areas without natural daylight gets adjusted higher on days with high exterior light levels (e.g. when leaving a bureau with windows into a corridor without windows the light level change should be not too drastic).

In a further aspect, the building 5 is divided into illumination zones 41, 43, defining areas in dependence of their distance to interfaces 45 to natural daylight like the entrance or windows. The illumination level of the artificial lighting devices 17 is then more strictly adapted to the outside illumination, if the current zone is nearer to an interface 45 to the outside. In turn, zones 43 that are more remote to the outside of the building 5 will receive less modulation of the brightness levels.

FIG. 4 depicts a ground plan of a building 5 divided into two illumination zones: a non-central first illumination zone 41 surrounding the second illumination zone 43 at the center of the building 5. The first illumination zone 41 having more direct illumination from outside the building 5 than the second illumination zone 43. The illumination level of the artificial lighting devices 17 located in the first illumination zone 41 is then more strictly adapted to the outside illumination, because it is nearer to the interfaces 45 to the outside. In turn, zones that are more remote from the outside will receive less modulation of the brightness levels. FIG. 4 furtheron shows the luminous flux characteristic curves 47, 49 corresponding to the first illumination zone 41 and the second illumination zone 43.

In the photovoltaic world the term maximum power point tracking (MPPT) is well known for an iterative approach to keep input impedance of the solar converter on the maximum power point MPP which is dependent on the solar flux and other parameters and fluctuates over time. The MPP control mechanism gives a good measure for the energy available and can beneficially be directly used to steer the artificial light control value.

An additional effect can be exploited with this control scheme. LEDs get more efficient in terms of lm/W if their drive current gets reduced. So if dimming is reducing the drive current the light level will reduce with a smaller ratio than the input power making the system more efficient at intermediate external flux levels.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. Method for controlling the luminous flux of a lighting arrangement for illuminating the interiour of a building, wherein the lighting arrangement comprises at least one artificial lighting device, which artificial lighting device is supplied with electrical power by a power source system comprising a first power source being a photovoltaic device for generating electrical power and an access to at least one second power source, the method comprising the steps of:
Pre-selecting a luminous flux characteristic curve, which specifies a monotonically increasing dependence of the luminous flux of the artificial lighting device on the light intensity outside the building;
Determining the light intensity outside the building; and
Supplying the at least one artificial lighting device with the electrical power required for generating the luminous flux according to said selected luminous flux characteristic curve, wherein the photovoltaic device has a power contribution to said amount of required electrical power.

2. The method according to claim 1, wherein the luminous flux characteristic curve shows a linear relation between light intensity outside the building and the luminous flux of the artificial lighting device in at least one range of values between a lower limit of luminous flux and an upper limit of the luminous flux.

3. The method according to claim 2, wherein the lower limit of the luminous flux is a minimal luminous flux guaranteing the functional illuminating conditions in the building or at least a respective part of the building illuminated by the corresponding artificial lighting device.

4. The method according to claim 1, wherein the contribution to said amount of electrical power is a contribution corresponding to the current maximum performance level of the photovoltaic device up to the electrical power needed for the maximum luminous flux of the artificial lighting device.

5. The method according to claim 1, wherein the lighting arrangement comprises a plurality of artificial lighting devices.

6. The method according to claim 5, wherein the building is devided into different illumination zones, each with at least one corresponding artificial lighting device for illuminating the respective illumination zone, wherein the artificial lighting devices of at least two illumination zones have different luminous flux characteristic curves.

7. The method according to claim 6, wherein a first illumination zone has more direct illumination from outside the building than a second illumination zone and wherein a first luminous flux characteristic curve of the artificial lighting device of the first illumination zone shows a stronger dependence on the exterior light intensity outside the building than a second luminous flux characteristic curve of the artificial lighting device of the second illuminating zone.

8. The method according to claim 1, wherein the at least one artificial lighting device is at least one compact fluorescent lamp and/or at least one light emitting diode.

9. The method according to claim 1, wherein the light intensity outside the building is determined by the use of a light sensor.

10. The method according to claim 1, wherein the light intensity outside the building is determined by the use of an operational parameter of the photovoltaic device.

11. The method according to claim 10, wherein the operational parameter is the output electrical power of the photovoltaic device.

12. A photovoltaic lighting system, especially a photovoltaic lighting system for performing a method according to claim 1, comprising a lighting arrangement for an internal illumination of a building, a controller and a power source system for supplying the lighting arrangement, wherein the lighting arrangement comprises at least one artificial lighting device and wherein the power source system comprises a first power source being a photovoltaic device for generating electrical power and an access to at least one second power source wherein said power source system supplies the artificial lighting device with an adequad amount of electrical power required for generating a luminous flux according to a pre-selectable luminous flux characteristic curve by means of the controller, wherein a power contribution of the the photovoltaic device to said amount of electrical power is selectable by means of the controller.

13. A photovoltaic lighting system according to claim 13, further comprising a dimmable driver device, wherein the controller controlls the electrical power supply to the artificial lighting device by means of the dimmable driver device.

14. (canceled)
